(19) United States
(12) Patent Application Publication
(10) Pub. No.: US 2007/0134139 A1
(43) Pub. Date: Jun. 14, 2007

(54) Plasma reactor and exhaust gas reduction apparatus of a vehicle including the same

(76) Inventors: Kwang Ok Choi, Hwaseong-city (KR); Yone Seung Kim, Suwon-city (KR); Tae Han Jee, Anyang-city (KR); Hyung Jei Cho, Yongin-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/305,725

(22) Filed: Dec. 15, 2005

(30) Foreign Application Priority Data
Dec. 9, 2005 (KR) 10-2005-0120950

(51) Int. Cl. B01J 19/08

(52) U.S. Cl. 422/186.04

(57) ABSTRACT

A plasma reactor of the present invention includes a plurality of electrode units, at least two spacers, a first connection unit, and a second connection unit, wherein the plurality of electrode units are mutually layered, the at least two spacers are positioned into each space between the plurality of electrode units, the first connection unit electrically connects odd numbered electrode units of the plurality of electrode units with each other, and the second connection unit electrically connects even numbered electrode units of the plurality of electrode units with each other.

### CROSS-REFERENCE TO RELATED APPLICATION

This application claims priority to and the benefit of Korean Patent Application No. 10-2005-0120950 filed in the Korean Intellectual Property Office on Dec. 09, 2005, the entire contents of which are incorporated herein by reference.

### BACKGROUND OF THE INVENTION

(a) Field of the Invention

The present invention relates to a plasma reactor, and in particular to a plasma reactor for reducing exhaust gas of a vehicle.

(b) Description of the Related Art

Diesel engines are becoming more prevalent because of their high efficiency and fuel economy compared to gasoline engines. Accordingly, demand for such diesel engines is increasing. However, diesel engine emissions are strongly regulated. Therefore many schemes for reducing air diesel engine emissions are being investigated.

One scheme utilizes a plasma reaction. This has been recognized as promising technology because it can reduce oxidized nitrogen (NOx) and diesel particulate matter (PM) at the same time.

In addition, various corona-generating apparatuses for forming plasma are being investigated. However, such conventional apparatuses may have problems of safety and durability due to the occurance of sparks.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a plasma reactor having advantages of enhanced safety and durability.

In addition, the present invention has been made in an effort to provide an exhaust gas reduction apparatus of a vehicle including the plasma reactor.

An exemplary plasma reactor according to an embodiment of the present invention includes a plurality of electrode units that are mutually layered, at least two spacers that are positioned into each space between the plurality of electrode units, a first connection unit for electrically connecting odd numbered electrode units of the plurality of electrode units with each other, and a second connection unit for electrically connecting even numbered electrode units of the plurality of electrode units with each other.

In a further embodiment, the plurality of electrode units includes a first electrode unit, and the first electrode unit includes a first dielectric material, a first main electrode that is printed onto a first surface of the first dielectric material, a second dielectric material, and a second main electrode that is printed onto a first surface of the second dielectric material. The first main electrode and the second main electrode have a surface-contact with each other.

In a further embodiment, the first and second main electrodes are respectively positioned within each surface of the first and second dielectric materials, and the first and second main electrodes are respectively biased to a left side with respect to each center of the first and second dielectric materials by a predetermined distance, so as to be prevented from contacting with the second connection unit.

In a further embodiment, the at least two spacers include first and second spacers that are respectively positioned into both sides of each space between the plurality of electrode units; the first connection unit penetrates the first dielectric material, the second dielectric material, and the first spacer so as to electrically connect the odd numbered electrode units with each other; and the second connection unit penetrates the first dielectric material, the second dielectric material, and the second spacer so as to electrically connect the even numbered electrode units with each other.

In a further embodiment, the first connection unit includes: first, second, and third penetration holes that are respectively formed at the first dielectric material, the second dielectric material, and the first spacer, and which are positioned on a vertical line of the first spacer; a first insert electrode that is inserted into the first penetration hole, and which has a surface-contact with the first main electrode; a second insert electrode that is inserted into the second penetration hole, and which has a surface-contact with the second main electrode; a third insert electrode that is inserted into the third penetration hole; a first auxiliary electrode that is printed onto a second surface of the first dielectric material, and which has a surface-contact with the first insert electrode; a second auxiliary electrode that is printed onto a second surface of the second dielectric material, and which has a surface-contact with the second insert electrode; and third and fourth auxiliary electrodes that are respectively printed onto both surfaces of the first spacer, and which respectively have a surface-contact with both ends of the third insert electrode.

In a further embodiment, each of the first, second, third, and fourth auxiliary electrodes is positioned within each surface of the first dielectric material, the first spacer, and the second dielectric material, and each width of the first, second, third, and fourth auxiliary electrodes is longer than each diameter of the first, second, and third insert electrodes and is shorter than the width of the first spacer.

In a further embodiment, the second connection unit includes fourth, fifth, and sixth penetration holes that are formed at the first dielectric material, the second dielectric material, and the second spacer, and which are positioned on a vertical line of the second spacer; fourth, fifth, and sixth insert electrodes that are respectively inserted into the fourth, fifth, and sixth penetration holes; fifth and sixth auxiliary electrodes that are respectively printed onto both surfaces of the first dielectric material, and which respectively have a surface-contact with both ends of the fourth insert electrode; seventh and eighth auxiliary electrodes that are respectively printed onto both surfaces of the second dielectric material, and which respectively have a surface-contact with both ends of the fifth insert electrode; and ninth and tenth auxiliary electrodes that are respectively printed onto both surfaces of the second spacer, and which are respectively contacted with both ends of the sixth insert electrode.

In a further embodiment, each of the fifth, sixth, seventh, eighth, ninth, and tenth auxiliary electrodes is positioned within each surface of the first dielectric material, the second spacer, and the second dielectric material, and each width of the fifth, sixth, seventh, eighth, ninth, and tenth auxiliary electrodes is longer than each diameter of the fourth, fifth, and sixth insert electrodes and is shorter than the width of the second spacer.

In a further embodiment, a first predetermined gap between the first main electrode and the sixth auxiliary electrode is defined as a minimum value in which the first main electrode and the sixth auxiliary electrode are insulated from each other, and a second predetermined gap between the second main electrode and the seventh auxiliary electrode is defined as a minimum value in which the second main electrode and the seventh auxiliary electrode are insulated from each other.

In a further embodiment, the first predetermined gap is defined as (1 mm±0.1 mm)/1 KV according to a voltage difference between the first main electrode and the sixth auxiliary electrode, and the second predetermined gap is defined as (1 mm±0.1 mm)/1 KV according to a voltage difference between the second main electrode and the seventh auxiliary electrode.

In a further embodiment, the plurality of electrode units further includes a second electrode unit, and the second electrode unit includes a third dielectric material, a third main electrode that is printed onto a first surface of the third dielectric material, a fourth dielectric material, and a fourth main electrode that is printed onto a first surface of the fourth dielectric material. The third main electrode and the fourth main electrode have a surface-contact with each other.

In a further embodiment, the third and fourth main electrodes are respectively positioned within each surface of the third and fourth dielectric materials, and the third and fourth main electrodes are respectively biased to a right side with respect to each center of the third and fourth dielectric materials by a predetermined distance, so as to be prevented from contacting with the first connection unit.

In a further embodiment, the first connection unit includes: seventh and eighth penetration holes that are respectively formed at the third and fourth dielectric materials, and which are positioned on a vertical line of the first spacer; seventh and eighth insert electrodes that are respectively inserted into the seventh and eighth penetration holes; eleventh and twelfth auxiliary electrodes that are respectively printed onto both surfaces of the third dielectric material, and which respectively have a surface-contact with both ends of the seventh insert electrode; and thirteenth and fourteenth auxiliary electrodes that are respectively printed onto both surfaces of the fourth dielectric material, and which respectively have a surface-contact with both ends of the eighth insert electrode.

In a further embodiment, each of the eleventh, twelfth, thirteenth, and fourteenth auxiliary electrodes is positioned within each surface of the third and fourth dielectric materials, and each width of the eleventh, twelfth, thirteenth, and fourteenth auxiliary electrodes is longer than each diameter of the seventh and eighth insert electrodes and is shorter than the width of the first spacer.

In a further embodiment, a third predetermined gap between the third main electrode and the twelfth auxiliary electrode is defined as a minimum value in which the third main electrode and the twelfth auxiliary electrode are insulated from each other, and a fourth predetermined gap between the fourth main electrode and the thirteenth auxiliary electrode is defined as a minimum value in which the fourth main electrode and the thirteenth auxiliary electrode are insulated from each other.

In a further embodiment, the third predetermined gap is defined as (1 mm±0.1 mm)/1 KV according to a voltage difference between the third main electrode and the twelfth auxiliary electrode, and the fourth predetermined gap is defined as (1 mm±0.1 mm)/1 KV according to a voltage difference between the fourth main electrode and the thirteenth auxiliary electrode.

In a further embodiment, the second connection unit includes ninth and tenth penetration holes that are respectively formed at the third and fourth dielectric materials, and which are positioned on a vertical line of the second spacer; a ninth insert electrode that is inserted into the ninth penetration hole, and which has a surface-contact with the third main electrode; a tenth insert electrode that is inserted into the tenth penetration hole, and which has a surface-contact with the fourth main electrode; a fifteenth auxiliary electrode that is printed onto a second surface of the third dielectric material, and which has a surface-contact with the ninth insert electrode; and a sixteenth auxiliary electrode that is printed onto a second surface of the fourth dielectric material, and which has a surface-contact with the tenth insert electrode.

In a further embodiment, the fifteenth and sixteenth auxiliary electrodes are respectively positioned within each surface of the third and fourth dielectric materials, and each width of the fifteenth and sixteenth auxiliary electrodes is longer than each diameter of the ninth and tenth insert electrodes and is shorter than the width of the second spacer.

An exemplary exhaust gas reduction apparatus of a vehicle according to another embodiment of the present invention includes: a housing that is disposed on one side of a vehicle engine so as to receive exhaust gas from the vehicle engine; a plasma reactor that is disposed in the housing, and in which a plasma region is formed so as to flow the exhaust gas thereinto; and a mat that is disposed between the plasma reactor and the housing.

In a further embodiment, the plasma reactor includes: a plurality of electrode units that are mutually layered; at least two spacers that are positioned into each space between the plurality of electrode units; a first connection unit for electrically connecting odd numbered electrode units of the plurality of electrode units with each other; and a second connection unit for electrically connecting even numbered electrode units of the plurality of electrode units with each other.

In a further embodiment, the plurality of electrode units includes a first electrode unit, and the first electrode unit includes a first dielectric material, a first main electrode that is printed onto a first surface of the first dielectric material, a second dielectric material, and a second main electrode that is printed onto a first surface of the second dielectric material. The first main electrode and the second main electrode have a surface-contact with each other.

### BRIEF DESCRIPTION OF THE DRAWINGS

FIG. 1 is a schematic view showing a plasma reactor according to an exemplary embodiment of the present invention.

FIG. 2 is a top plan view of a first dielectric material showing a state in which a first main electrode and a sixth auxiliary electrode are printed onto the first dielectric material, in a plasma reactor according to an exemplary embodiment of the present invention.

FIG. 3 is a lower plan view of the first dielectric material showing a state in which a first auxiliary electrode and fifth auxiliary electrode are printed onto the first dielectric material, in a plasma reactor according to an exemplary embodiment of the present invention.

FIG. 4 is a lower plan view of a first spacer showing a state in which a third auxiliary electrode is printed onto the first spacer, in a plasma reactor according to an exemplary embodiment of the present invention.

FIG. 5 is a top plan view of the first spacer showing a state in which a fourth auxiliary electrode is printed onto the first spacer, in a plasma reactor according to an exemplary embodiment of the present invention.

FIG. 6 is a perspective view showing an exhaust gas reduction apparatus of a vehicle according to another exemplary embodiment of the present invention.

### DESCRIPTION OF REFERENCE NUMERALS INDICATING PRIMARY ELEMENTS IN THE DRAWINGS

| | |
|---|---|
| 10: electrode unit | 30: spacer |
| 50: first connection unit | 70: second connection unit |
| 100: first electrode unit | 200: second electrode unit |
| 110: first dielectric material | 120: first main electrode |
| 130: second dielectric material | 140: second main electrode |

510, 520, 530: first, second, and third penetration holes
540, 550, 560: first, second, and third insert electrodes
610, 620, 630, 640: first, second, third, and fourth auxiliary
electrodes
710, 720, 730: fourth, fifth, and sixth penetration holes
740, 750, 760: fourth, fifth, and sixth insert electrodes
810, 820, 830, 840, 850, 860: fifth, sixth, seventh, eighth,
ninth, and tenth auxiliary electrodes

### DETAILED DESCRIPTION OF THE EMBODIMENTS

With reference to the accompanying drawings, the present invention will be described in order for those skilled in the art to be able to implement the invention. As those skilled in the art would realize, the described embodiments may be modified in various different ways, all without departing from the spirit or scope of the present invention.

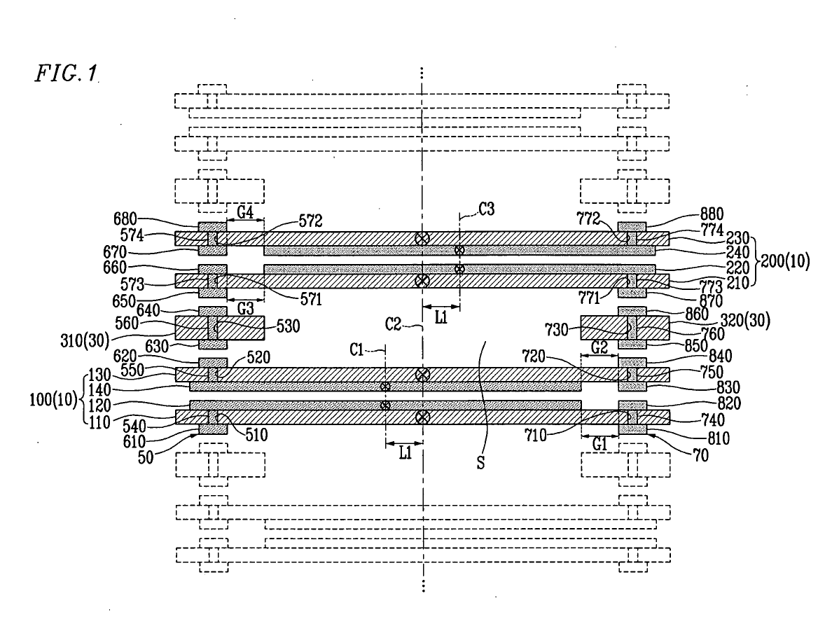

FIG. 1 is a schematic view showing a plasma reactor according to an exemplary embodiment of the present invention.

A plasma reactor according to an exemplary embodiment of the present invention, as shown in FIG. 1, includes a plurality of electrode units 10, at least two spacers 30, a first connection unit 50, and a second connection unit 70.

The plurality of electrode units 10 are mutually layered and at least two spacers 30 are positioned into each space between the plurality of electrode units 10 so as to form a plasma region S.

The first connection unit 50 electrically connects odd numbered electrode units (refer to “100” in FIG. 1) of the plurality of electrode units 10 with each other, and the second connection unit 70 electrically connects even numbered electrode units (refer to “200” in FIG. 1) of the plurality of electrode units 10 with each other.

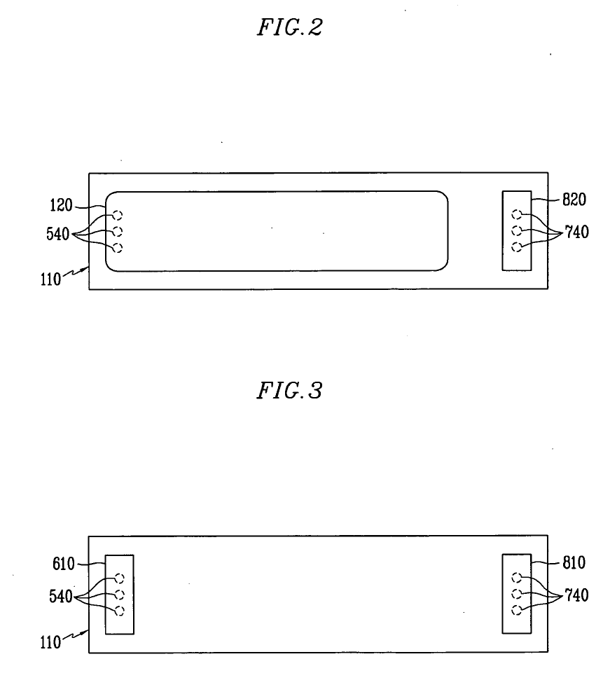

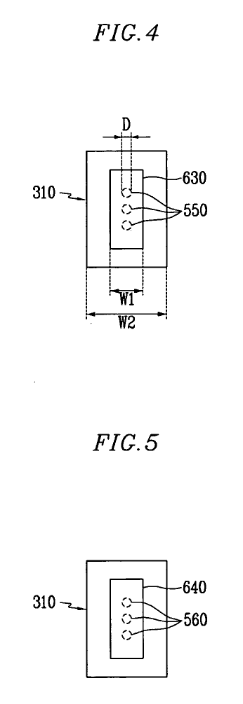

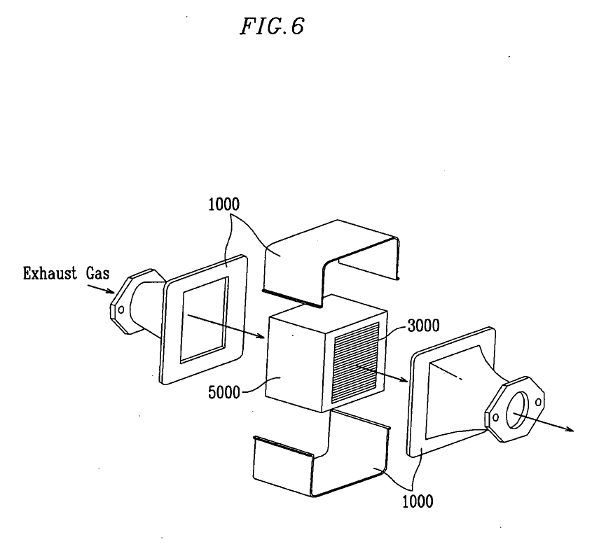

With reference to FIG. 1 to FIG. 5, the plurality of electrode units 10 will be hereinafter described in detail.

The plurality of electrode units 10 includes a first electrode unit 100 and a second electrode unit 200 so as to form the plasma region S. In addition, voltages which are respectively applied to both of the first electrode unit 100 and the second electrode unit 200 are different to each other, so as to generate a voltage difference between the first electrode unit 100 and the second electrode unit 200. By such a voltage difference, corona discharge is formed in the plasma region S.

In more detail, the first electrode unit 100 includes a first dielectric material 110, a first main electrode 120, a second dielectric material 130, and a second main electrode 140.

The first main electrode 120 is formed of a conductive material and directly receives voltage. In addition, the first main electrode 120 is printed onto a first surface of the first dielectric material 110 such that a gap is prevented from being formed between the first dielectric material 110 formed of an insulator material and the first main electrode 120 formed of a conductive material. Therefore, a spark which may be produced by the gap can be prevented. In addition, the second main electrode 140 is printed onto a first surface of the second dielectric material 130 so as to prevent a gap therebetween. Furthermore, the first main electrode 120 and the second main electrode 140 are not printed onto each other but only have a surface-contact with each other since a spark is not produced due to characteristics of the conductive material even if a gap is formed therebetween.

In addition, the first and second main electrodes 120 and 140 are respectively positioned within each surface of the first and second dielectric materials 110 and 130, so as to be prevented from contacting with an exterior member (not shown), that is, such that high voltage is not transmitted to the exterior member (not shown). Therefore, damage due to the high voltage can be prevented. In addition, each center C1 of the first and second main electrodes 120 and 140 is respectively biased to a left side with respect to each center C2 of the first and second dielectric materials 110 and 130 by a predetermined distance L1, so as to be prevented from contacting with the second connection unit 70. In addition, the at least two spacers 30 includes first and second spacers that are respectively positioned into both sides of a plasma region S between the first electrode unit 100 and the second electrode unit 200.

In addition, the first connection unit 50 penetrates the first dielectric material 110, the second dielectric material 130, and the first spacer 310 so as to electrically connect the odd numbered electrode units (refer to “100” in FIG. 1) with each other, and the second connection unit 70 penetrates the first dielectric material 110, the second dielectric material 130, and the second spacer 320 so as to electrically connect the even numbered electrode units (refer to “200” in FIG. 1) with each other. In particular, with such a penetrating scheme, high voltage that is transmitted through the first and second connection units 50 and 70 is not transmitted to the exterior member (not shown), and accordingly damage due to the high voltage can be prevented.

With reference to FIGS. 1 to 5, the first connection unit 50 will be hereinafter described in detail.

The first connection unit 50 includes first, second, and third penetration holes 510, 520, and 530, first, second, and third insert electrodes 540, 550, and 560, and first, second, third, and fourth auxiliary electrodes 610, 620, 630, and 640.

The first, second, and third penetration holes 510, 520, and 530 are respectively formed at the first dielectric material 110, the second dielectric material 130, and the first spacer 310, and they are positioned on a vertical line of the first spacer 310.

The first insert electrode 540 is inserted into the first penetration hole 510, a first end thereof has a surface-contact with the first main electrode 120, and a second end thereof has a surface-contact with the first auxiliary electrode 610.

The second insert electrode 550 is inserted into the second penetration hole 520, a first end thereof has a surface-contact with the second main electrode 140, and a second end thereof has a surface-contact with the second auxiliary electrode 620.

The third insert electrode 560 is inserted into the third penetration hole 530, a first end thereof has a surface-contact with the third auxiliary electrode 630, and a second end thereof has a surface-contact with the fourth auxiliary electrode 640.

Furthermore, in order to prevent a spark from being produced due to a gap, the first auxiliary electrode 610 is printed onto a second surface of the first dielectric material 110, the second auxiliary electrode 620 is printed onto a second surface of the second dielectric material 130, the third auxiliary electrode 630 is printed onto a first surface of the first spacer 310, and the fourth auxiliary electrode 640 is printed onto a second surface of the first spacer 310. Such first, second, third, and fourth auxiliary electrodes 610, 620, 630, and 640 may be formed of a conductive material. In particular, the second auxiliary electrode 620 and the third auxiliary electrode 630 are not printed onto each other but only have a surface-contact with each other since a spark is not produced due to characteristics of the conductive material even if a gap is formed therebetween.

In addition, each of the first, second, third, and fourth auxiliary electrodes 610, 620, 630, and 640 is positioned within each surface of the first dielectric material 110, the first spacer 310, and the second dielectric material 130, so as to be prevented from contacting with an exterior member (not shown). In addition, as shown in FIG. 4, each width W1 of the first, second, third, and fourth auxiliary electrodes 610, 620, 630, and 640 is longer than each diameter D of the first, second, and third insert electrodes 540, 550, and 560, and it is shorter than width W2 of the first spacer 310.

With reference to FIGS. 1 to 5, the second connection unit 70 will be hereinafter described in detail.

The second connection unit 70 includes fourth, fifth, and sixth penetration holes 710, 720, and 730, fourth, fifth, and sixth insert electrodes 740, 750, and 760, and fifth, sixth, seventh, eighth, ninth, and tenth auxiliary electrodes 810, 820, 830, 840, 850, and 860.

The fourth, fifth, and sixth penetration holes 710, 720, and 730 are respectively formed at the first dielectric material 110, the second dielectric material 130, and the second spacer 320, and they are positioned on a vertical line of the second spacer 320.

The fourth insert electrode 740 is inserted into the fourth penetration hole 710, a first end thereof has a surface-contact with the fifth auxiliary electrode 810, and a second end thereof has a surface-contact with the sixth auxiliary electrode 820.

The fifth insert electrode 750 is inserted into the fifth penetration hole 720, a first end thereof has a surface-contact with the seventh auxiliary electrode 830, and a second end thereof has a surface-contact with the eighth auxiliary electrode 840.

The sixth insert electrode 760 is inserted into the sixth penetration hole 730, a first end thereof has a surface-contact with the ninth auxiliary electrode 850, and a second end thereof has a surface-contact with the tenth auxiliary electrode 860.

Furthermore, in order to prevent a spark from being produced due to a gap, the fifth and sixth auxiliary electrodes 810 and 820 are respectively printed onto both surfaces of the first dielectric material 110, the seventh and eighth auxiliary electrodes 830 and 840 are respectively printed onto both surfaces of the second dielectric material 130, and the ninth and tenth auxiliary electrodes 850 and 860 are respectively printed onto both surfaces of the second spacer 320. Such fifth, sixth, seventh, eighth, ninth, and tenth auxiliary electrodes 810, 820, 830, 840, 850, and 860 may be formed of a conductive material. In particular, the sixth auxiliary electrode 820 and the seventh auxiliary electrode 830 are not printed onto each other but only have a surface-contact with each other since a spark is not produced due to characteristics of the conductive material even if a gap is formed therebetween. The eighth auxiliary electrode 840 and the ninth auxiliary electrode 850 also have a surface-contact with each other for the same reason.

In addition, each of the fifth, sixth, seventh, eighth, ninth, and tenth auxiliary electrodes 810, 820, 830, 840, 850, and 860 is positioned within each surface of the first dielectric material 110, the second spacer 320, and the second dielectric material 130, so as to be prevented from contacting with an exterior member (not shown). In addition, each width (refer to “W1” in FIG. 4) of the fifth, sixth, seventh, eighth, ninth, and tenth auxiliary electrodes 810, 820, 830, 840, 850, and 860 is longer than each diameter (refer to “D” in FIG. 4) of the fourth, fifth, and sixth insert electrodes 740, 750, and 760 and is shorter than the width (refer to “W2” in FIG. 4) of the second spacer 320.

In addition, a first predetermined gap G1 between the first main electrode 120 and the sixth auxiliary electrode 820 is defined as a minimum value in which the first main electrode 120 and the sixth auxiliary electrode 820 are insulated from each other. A second predetermined gap G2 between the second main electrode 140 and the seventh auxiliary electrode 830 is also defined as a minimum value in which the second main electrode 140 and the seventh auxiliary electrode 830 are insulated from each other. In more detail, the first predetermined gap G1 is defined as (1 mm±0.1 mm)/1 KV according to a voltage difference between the first main electrode 120 and the sixth auxiliary electrode 820, and the second predetermined gap G2 is defined as (1 mm±1 mm)/1 KV according to a voltage difference between the second main electrode 140 and the seventh auxiliary electrode 830.

With reference to FIG. 1, the second electrode unit 200 of the plurality of electrode units 10 will be hereinafter described in detail.

The second electrode unit 200 includes a third dielectric material 210, a third main electrode 220, a fourth dielectric material 230, and a fourth main electrode 240.

The third main electrode 220 is formed of a conductive material and directly receives voltage. In addition, the third main electrode 220 is printed onto a first surface of the third dielectric material 210 such that a gap is prevented from being formed between the third dielectric material 210 formed of an insulator material and the third main electrode 220 formed of a conductive material. Therefore, a spark which may be produced by the gap can be prevented. In addition, the fourth main electrode 240 is printed onto a first surface of the fourth dielectric material 230 so as to prevent a gap therebetween. Furthermore, the third main electrode 220 and the fourth main electrode 240 are not printed onto each other but only have a surface-contact with each other since a spark is not produced due to characteristics of the conductive material even if a gap is formed therebetween.

In addition, the third and fourth main electrodes 220 and 240 are respectively positioned within each surface of the third and fourth dielectric materials 210 and 230, so as to be prevented from contacting with an exterior member (not shown), that is, such that high voltage is not transmitted to the exterior member (not shown). Therefore, damage due to the high voltage can be prevented. In addition, each center C3 of the third and fourth main electrodes 220 and 240 is respectively biased to a right side with respect to each center C2 of the third and fourth dielectric materials 210 and 230 by a predetermined distance L1, so as to be prevented from contacting with the first connection unit 50.

On the other hand, if the second electrode unit 200 is further included, the first connection unit 50 may further include the following constituent elements.

The first connection unit 50 further includes seventh and eighth penetration holes 571 and 572, seventh and eighth insert electrodes 573 and 574, and eleventh, twelfth, thirteenth, and fourteenth auxiliary electrodes 650, 660, 670, and 680.

The seventh and eighth penetration holes 571 and 572 are respectively formed at the third and fourth dielectric materials 210 and 230, and they are positioned on a vertical line of the first spacer 310.

The seventh insert electrode 573 is inserted into the seventh penetration hole 571, a first end thereof has a surface-contact with the eleventh auxiliary electrode 650, and a second end has a surface-contact with the twelfth auxiliary electrode 660.

The eighth insert electrode 574 is inserted into the eighth penetration hole 572, a first end thereof has a surface-contact with the thirteenth auxiliary electrode 670, and a second end thereof has a surface-contact with the fourteenth auxiliary electrode 680.

Furthermore, in order to prevent a spark from being produced due to a gap, the eleventh and twelfth auxiliary electrodes 650 and 660 are respectively printed onto both surfaces of the third dielectric material 210, and the thirteenth and fourteenth auxiliary electrodes 670 and 680 are respectively printed onto both surfaces of the fourth dielectric material 230. Such eleventh, twelfth, thirteenth, and fourteenth auxiliary electrodes 650, 660, 670, and 680 may be formed of a conductive material. In particular, the fourth auxiliary electrode 640 and the eleventh auxiliary electrode 650 are not printed onto each other but only have a surface-contact with each other since a spark is not produced due to characteristics of the conductive material even if a gap is formed therebetween. The twelfth auxiliary electrode 660 and the thirteenth auxiliary electrode 670 also have a surface-contact with each other for the same reason.

In addition, each of the eleventh, twelfth, thirteenth, and fourteenth auxiliary electrodes 650, 660, 670, and 680 is positioned within each surface of the third and fourth dielectric materials 210 and 230, so as to be prevented from contacting with an exterior member (not shown). In addition, each width (refer to “W1” in FIG. 4) of the eleventh, twelfth, thirteenth, and fourteenth auxiliary electrodes 650, 660, 670, and 680 is longer than each diameter (refer to “D” in FIG. 4) of the seventh and eighth insert electrodes 573 and 574 and is shorter than the width (refer to “W2” in FIG. 4) of the first spacer 310.

In addition, a third predetermined gap G3 between the third main electrode 220 and the twelfth auxiliary electrode 660 is defined as a minimum value in which the third main electrode 220 and the twelfth auxiliary electrode 660 are insulated from each other. A fourth predetermined gap G4 between the fourth main electrode 240 and the thirteenth auxiliary electrode 670 is also defined as a minimum value in which the fourth main electrode 240 and the thirteenth auxiliary electrode 670 are insulated from each other. In more detail, the third predetermined gap G3 is defined as (1 mm±0.1 mm)/1 KV according to a voltage difference between the third main electrode 220 and the twelfth auxiliary electrode 660, and the fourth predetermined gap G4 is defined as (1 mm±0.1 mm)/1 KV according to a voltage difference between the fourth main electrode 240 and the thirteenth auxiliary electrode 670.

In addition, if the second electrode unit 200 is further included, the second connection unit 70 may further include the following constituent elements.

The second connection unit 70 further includes ninth and tenth penetration holes 771 and 772, ninth and tenth insert electrodes 773 and 774, and fifteenth and sixteenth auxiliary electrodes 870 and 880.

The ninth and tenth penetration holes 771 and 772 are respectively formed at the third and fourth dielectric materials 210 and 230, and they are positioned on a vertical line of the second spacer 320.

The ninth insert electrode 773 is inserted into the ninth penetration hole 771, a first end thereof has a surface-contact with the fifteenth auxiliary electrode 870, and a second end thereof has a surface-contact with the third main electrode 220.

The tenth insert electrode 774 is inserted into the tenth penetration hole 772, a first end thereof has a surface-contact with the fourth main electrode 240, and a second end thereof has a surface-contact with the sixteenth auxiliary electrode 880.

Furthermore, in order to prevent a spark from being produced due to a gap, the fifteenth auxiliary electrode 870 is printed onto a first surface of the third dielectric material 210, and the sixteenth auxiliary electrode 880 is printed onto a second surface of the fourth dielectric material 230. Such fifteenth and sixteenth auxiliary electrodes 870 and 880 may be formed of a conductive material. In particular, the tenth auxiliary electrode 860 and the fifteenth auxiliary electrode 870 are not printed onto each other but only have a surface-contact with each other since a spark is not produced due to characteristics of the conductive material even if a gap is formed therebetween.

In addition, each of the fifteenth and sixteenth auxiliary electrodes 870 and 880 is positioned within each surface of the third and fourth dielectric materials 210 and 230, so as to be prevented from contacting with an exterior member (not shown). In addition, each width (refer to “W1” in FIG. 4) of the fifteenth and sixteenth auxiliary electrodes 870 and 880 is longer than each diameter (refer to “D” in FIG. 4) of the ninth and tenth insert electrodes 773 and 774 and is shorter than the width (refer to “W2” in FIG. 4) of the second spacer 320.

On the other hand, the first electrode unit 100 and the second electrode unit 200 may be repeatedly layered on the basis of the above-mentioned concept.

An operation of the plasma reactor according to an exemplary embodiment of the present invention will be hereinafter described.

If high voltage is applied to the first connection unit 50, a corona discharge is formed in the plasma region S.

Electrons in the formed corona have high energies and form radicals by colliding with materials such as oxygen, nitrogen, and aqueous vapor. These radicals react with noxious materials and transform them into other materials, thus removing the noxious materials.

With reference to FIG. 6, an exhaust gas reduction apparatus of a vehicle according to another exemplary embodiment of the present invention will be hereinafter described in detail.

An exhaust gas reduction apparatus of a vehicle includes a housing 1000, a plasma reactor 3000, and a mat 5000.

The housing 1000 is disposed on one side of a vehicle engine so as to receive exhaust gas from the vehicle engine.

The mat 5000 is disposed between the plasma reactor 3000 and the housing 1000 so as to protect the plasma reactor 3000 from vibration of the vehicle. Furthermore, the mat 5000 is formed of an insulator material.

Since the plasma reactor 3000 is already described in the hereinabove plasma reactor according to an exemplary embodiment of the present invention, the detailed description thereof will be omitted here.

As has been explained, a plasma reactor and an exhaust gas reduction apparatus of a vehicle according to embodiments of the present invention may have the following advantages.

According to the embodiments of the present invention, since an electrode formed of a conductive material is printed onto a dielectric material formed of an insulator material, that is, since a gap is not formed between the electrode and the dielectric material, a spark that may be produced by the gap can be prevented. Consequently, durability of the plasma reactor can be enhanced.

In addition, according to the embodiments of the present invention, since the electrode with high voltage is not exposed, safety of the plasma reactor can be perfectly maintained.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma reactor comprising:
a plurality of electrode units that are mutually layered;
at least two spacers that are positioned into each space between the plurality of electrode units;
a first connection unit for electrically connecting odd numbered electrode units of the plurality of electrode units with each other; and
a second connection unit for electrically connecting even numbered electrode units of the plurality of electrode units with each other,
wherein the plurality of electrode units comprise a first electrode unit, and
the first electrode unit comprises:
a first dielectric material;
a first main electrode that is printed onto a first surface of the first dielectric material;
a second dielectric material; and
a second main electrode that is printed onto a first surface of the second dielectric material, and
wherein the first main electrode and the second main electrode have a surface-contact with each other.

2. The plasma reactor of claim 1, wherein:
the first and second main electrodes are respectively positioned within each surface of the first and second dielectric materials, and
the first and second main electrodes are respectively biased to a left side with respect to each center of the first and second dielectric materials by a predetermined distance, so as to be prevented from contacting with the second connection unit.

3. The plasma reactor of claim 1, wherein:
the at least two spacers comprises first and second spacers which are respectively positioned into both sides of each space between the plurality of electrode units;
the first connection unit penetrates the first dielectric material, the second dielectric material, and the first spacer so as to electrically connect the odd numbered electrode units with each other; and
the second connection unit penetrates the first dielectric material, the second dielectric material, and the second spacer so as to electrically connect the even numbered electrode units with each other.

4. The plasma reactor of claim 3, wherein the first connection unit comprises:
first, second, and third penetration holes that are respectively formed at the first dielectric material, the second dielectric material, and the first spacer, and which are positioned on a vertical line of the first spacer;
a first insert electrode that is inserted into the first penetration hole, and which has a surface-contact with the first main electrode;
a second insert electrode that is inserted into the second penetration hole, and which has a surface-contact with the second main electrode;
a third insert electrode that is inserted into the third penetration hole;
a first auxiliary electrode that is printed onto a second surface of the first dielectric material, and which has a surface-contact with the first insert electrode;
a second auxiliary electrode that is printed onto a second surface of the second dielectric material, and which has a surface-contact with the second insert electrode; and
third and fourth auxiliary electrodes that are respectively printed onto both surfaces of the first spacer, and which respectively have a surface-contact with both ends of the third insert electrode.

5. The plasma reactor of claim 4, wherein:
each of the first, second, third, and fourth auxiliary electrodes is positioned within each surface of the first dielectric material, the first spacer, and the second dielectric material; and
each width of the first, second, third, and fourth auxiliary electrodes is longer than each diameter of the first, second, and third insert electrodes and is shorter than the width of the first spacer.

6. The plasma reactor of claim 4, wherein the second connection unit comprises:
fourth, fifth, and sixth penetration holes that are formed at the first dielectric material, the second dielectric material, and the second spacer, and which are positioned on a vertical line of the second spacer;
fourth, fifth, and sixth insert electrodes that are respectively inserted into the fourth, fifth, and sixth penetration holes;
fifth and sixth auxiliary electrodes that are respectively printed onto both surfaces of the first dielectric material, and which respectively have a surface-contact with both ends of the fourth insert electrode;
seventh and eighth auxiliary electrodes that are respectively printed onto both surfaces of the second dielectric material, and which respectively have a surface-contact with both ends of the fifth insert electrode; and
ninth and tenth auxiliary electrodes that are respectively printed onto both surfaces of the second spacer, and which are respectively contacted with both ends of the sixth insert electrode.

7. The plasma reactor of claim 6, wherein:
each of the fifth, sixth, seventh, eighth, ninth, and tenth auxiliary electrodes is positioned within each surface of the first dielectric material, the second spacer, and the second dielectric material; and
each width of the fifth, sixth, seventh, eighth, ninth, and tenth auxiliary electrodes is longer than each diameter of the fourth, fifth, and sixth insert electrodes and is shorter than the width of the second spacer.

8. The plasma reactor of claim 7, wherein:
a first predetermined gap between the first main electrode and the sixth auxiliary electrode is defined as a minimum value in which the first main electrode and the sixth auxiliary electrode are insulated from each other; and
a second predetermined gap between the second main electrode and the seventh auxiliary electrode is defined as a minimum value in which the second main electrode and the seventh auxiliary electrode are insulated from each other.

9. The plasma reactor of claim 8, wherein:
the first predetermined gap is defined as (1 mm±0.1 mm)/1 KV according to a voltage difference between the first main electrode and the sixth auxiliary electrode; and
the second predetermined gap is defined as (1 mm±0.1 mm)/1 KV according to a voltage difference between the second main electrode and the seventh auxiliary electrode.

10. The plasma reactor of claim 6, wherein the plurality of electrode units further comprise a second electrode unit,
the second electrode unit comprising:
a third dielectric material;
a third main electrode that is printed onto a first surface of the third dielectric material;
a fourth dielectric material; and
a fourth main electrode that is printed onto a first surface of the fourth dielectric material, and
wherein the third main electrode and the fourth main electrode have a surface-contact with each other.

11. The plasma reactor of claim 10, wherein:
the third and fourth main electrodes are respectively positioned within each surface of the third and fourth dielectric materials; and
the third and fourth main electrodes are respectively biased to a right side with respect to each center of the third and fourth dielectric materials by a predetermined distance, so as to be prevented from contacting with the first connection unit.

12. The plasma reactor of claim 10, wherein the first connection unit comprises:
seventh and eighth penetration holes that are respectively formed at the third and fourth dielectric materials, and which are positioned on a vertical line of the first spacer;
seventh and the eighth insert electrodes that are respectively inserted into the seventh and eighth penetration holes;
eleventh and twelfth auxiliary electrodes that are respectively printed onto both surfaces of the third dielectric material, and which respectively have a surface-contact with both ends of the seventh insert electrode; and
thirteenth and fourteenth auxiliary electrodes that are respectively printed onto both surfaces of the fourth dielectric material, and which respectively have a surface-contact with both ends of the eighth insert electrode.

13. The plasma reactor of claim 12, wherein:
each of the eleventh, twelfth, thirteenth, and fourteenth auxiliary electrodes is positioned within each surface of the third and fourth dielectric materials; and
each width of the eleventh, twelfth, thirteenth, and fourteenth auxiliary electrodes is longer than each diameter of the seventh and eighth insert electrodes and is shorter than the width of the first spacer.

14. The plasma reactor of claim 13, wherein:
a third predetermined gap between the third main electrode and the twelfth auxiliary electrode is defined as a minimum value in which the third main electrode and the twelfth auxiliary electrode are insulated from each other; and
a fourth predetermined gap between the fourth main electrode and the thirteenth auxiliary electrode is defined as a minimum value in which the fourth main electrode and the thirteenth auxiliary electrode are insulated from each other.

15. The plasma reactor of claim 14, wherein:
the third predetermined gap is defined as (1 mm±0.1 mm)/1 KV according to a voltage difference between the third main electrode and the twelfth auxiliary electrode; and
the fourth predetermined gap is defined as (1 mm±0.1 mm)/1 KV according to a voltage difference between the fourth main electrode and the thirteenth auxiliary electrode.

16. The plasma reactor of claim 12, wherein:
the second connection unit comprises:
ninth and tenth penetration holes that are respectively formed at the third and fourth dielectric materials, and which are positioned on a vertical line of the second spacer;
a ninth insert electrode that is inserted into the ninth penetration hole, and which has a surface-contact with the third main electrode;
a tenth insert electrode that is inserted into the tenth penetration hole, and which has a surface-contact with the fourth main electrode;
a fifteenth auxiliary electrode that is printed onto a second surface of the third dielectric material, and which has a surface-contact with the ninth insert electrode; and
a sixteenth auxiliary electrode that is printed onto a second surface of the fourth dielectric material, and which has a surface-contact with the tenth insert electrode.

17. The plasma reactor of claim 16, wherein:
the fifteenth and sixteenth auxiliary electrodes are respectively positioned within each surface of the third and fourth dielectric materials; and
each width of the fifteenth and sixteenth auxiliary electrodes is longer than each diameter of the ninth and tenth insert electrodes and is shorter than the width of the second spacer.

18. An exhaust gas reduction apparatus of a vehicle, comprising:
a housing that is disposed on one side of a vehicle engine so as to receive exhaust gas from the vehicle engine;
a plasma reactor that is disposed in the housing, and in which a plasma region is formed so as to flow the exhaust gas thereinto; and
a mat that is disposed between the plasma reactor and the housing,
wherein the plasma reactor comprises:
a plurality of electrode units that are mutually layered;
at least two spacers that are positioned into each space between the plurality of electrode units;
a first connection unit for electrically connecting odd numbered electrode units of the plurality of electrode units with each other; and
a second connection unit for electrically connecting even numbered electrode units of the plurality of electrode units with each other,
wherein the plurality of electrode units comprises a first electrode unit, and
the first electrode unit comprises:
a first dielectric material;
a first main electrode that is printed onto a first surface of the first dielectric material;
a second dielectric material; and
a second main electrode that is printed onto a first surface of the second dielectric material, and
wherein the first main electrode and the second main electrode have a surface-contact with each other.
